(19) United States
(12) Patent Application Publication
(10) Pub. No.: US 2009/0112525 A1
(43) Pub. Date: Apr. 30, 2009

(54) System and Method for Evaluating the Effects of Natural Events on Structures and Individuals

(76) Inventor: Alon Adani, San Mateo, CA (US)

Correspondence Address: LAW OFFICES OF BARRY N. YOUNG, 200 PAGE MILL ROAD, SUITE 102, PALO ALTO, CA, 94306, US

(21) Appl. No.: 11/925,710

(22) Filed: Oct. 26, 2007

(51) Int. Cl. G06F 15/00

(52) U.S. Cl. 702/189

(57) ABSTRACT

A system and method comprising an expert system and knowledge base that stores expert knowledge and parameters that characterize structures such as buildings and their occupants, evaluates the effects of a natural and other triggering events, such as earthquakes, on the structures and occupants. The analysis is based upon data which characterize the triggering event, and parameters which characterize the structure, its locale, its environment, and the occupants. The effect of the triggering event is analyzed using the expert knowledge and characterizing data and parameters, and communicated to occupants and to others with recommendations of actions which can minimize damage and injury. The method and system takes into account natural and man-made objects in the vicinity of the structure, as well as the occurrence of other triggering events which could also affect the structure or occupants.

### BACKGROUND OF THE INVENTION

This invention relates generally to computer information and management systems, and more particularly to systems for evaluating the condition and effects on structures and their occupants of natural forces and triggering events.

It is well known that natural phenomena such as earthquakes, hurricanes, floods, storms and other such natural occurrences have the potential for substantial damage to structures such as buildings and other constructions, as well as the potential for causing injury to individuals within or in the vicinity of such structures. The likelihood of damage to the structure or injury to individuals is influenced by many different factors. Some of these factors relate to characteristics of the structure itself. Structural characteristics include, for example, the design of the structure, the materials used in its construction, its age, its maintenance history, and the condition of the structure at the time of occurrence of the event, and these characteristics determine the ability of the structure to withstand the forces and effects of natural events. Other factors are related to the situs of the structure, including the nature of the geological substrata of the land upon which the structure is built, as, for example, whether it is bedrock or landfill, which are particularly relevant in the case of earthquakes, and the location of the structure relative to other natural and man-made objects in the vicinity. Other factors that influence the likelihood of damage or injury relate to characteristics of the triggering event. For a natural event, factors such as the location of the event, its proximity to the structure, strength, duration, as well as the effects of other recent or concurrent events that might result producing in a greater overall effect are relevant. Additionally, factors that characterize the individual inhabitants or users of a structure, such as their age, health and physical condition are important for assessing the impact of an event on the individuals.

Owners or inhabitants of structures typically do not have sufficient knowledge or an understanding of either the structures or of the effects of triggering events on structures or individuals, generally, to permit them to evaluate of the impact of an event or to know the steps that can be taken following the occurrence of such an event to reduce the risk of damage and injury due to secondary effects. For example, few building owners or inhabitants have sufficient knowledge and understanding to evaluate the damage to a building following a natural event such as an earthquake or to know what actions should be taken to avoid further damage and possible injury to inhabitants, as, for example, due to possible collapse of a weakened structure, fire due to a gas leak, or respiratory problems caused by contaminated air due, for instance, to hazardous building materials that may have been released by the event. There are obvious steps such as turning off gas and electric utilities that can reduce the risk of fire. Other actions, however, may not be so obvious. For example, temporary reinforcement or repair of certain damages to structures, if done promptly, may go far to reducing the risk or amount of further damage. Most owners or occupants of structures, however, do not have sufficient experience or expertise to know what temporary reinforcements, repairs or other actions may be appropriate under the circumstances. Similarly, the risk of injury to persons who are older, infirm, or who suffer from certain health conditions may be reduced if appropriate steps are taken to address such conditions. Most individuals also would be unable to make a realistic assessment of the preventive measures that may be taken in advance of or steps that may be taken following a natural event to minimize the risk of damage and injury, and there are no tools readily available to assist such individuals in making critical decisions which are appropriate to particular conditions under exigent circumstances.

Furthermore, there are no tools available which permit owners of buildings or other structures or inhabitants of buildings to acquire in advance structural information about a structure and its environment, or to acquire specific profile information about individual occupants in order to enable analyses, recommendations, and appropriate notifications to be generated upon the occurrence of triggering events so that preparatory steps can be taken to minimize the risk of damage or injury. For example, based upon the location of a structure, its design, the materials used in its construction, and its infrastructure and systems, as well as any particular physical conditions, sensitivities or preferences of occupants, appropriate preventive maintenance schedules may be produced for different assumed events that may occur. If maintenance is performed timely and appropriately, this can reduce the risk of damage or injury.

It is desirable to provide systems and methods which address the foregoing and other known problems of evaluating and minimizing the effects of events on structures and individuals, and it is to these ends that the present invention is directed.

### SUMMARY OF THE INVENTION

The invention affords computer information and management systems that address the foregoing and other known problems of addressing the effects of triggering events on structures and individuals by enabling information and parameters particular to structures and individuals such as their occupants, inhabitants and users to be collected and stored so that upon the occurrence of an event, the impact of that event upon the structure and individuals can be readily evaluated and appropriate actions taken to minimize the risk of damage or injury.

In one aspect, the invention provides a method for evaluating the effect of a triggering event at a structure that includes receiving notification of the event and data that characterize the event, and obtaining structural parameters characterizing the structure and conditions and preferences of one or more inhabitants. The effects of the event at the structure are analyzed using data and parameters which characterize the event, the structure, and weighting factors assigned to one or more of the structural parameters based upon user input, and the results of the analysis are reported.

In yet another aspect, the invention affords a system for evaluating the effect of a triggering event at a structure that comprises a knowledge base for storing expert knowledge and parameters that characterize the structure and weighting factors for one or more of the structural parameters that are assigned based upon user input, and an interface for receiving data that characterize the triggering event. An expert system analyzes the knowledge, parameters and event data to determine the effect of the event at the structure, and a module reports the analysis.

In accordance with another aspect, the invention affords a program product for storing instructions for controlling the operation of a computer to analyze the effect of a triggering event at a structure for receiving notification of the event and data that characterize the event, and obtaining structural parameters characterizing the structure and conditions and preferences of one or more inhabitants. The effects of the event at the structure are analyzed using data and parameters which characterize the event, the structure, and weighting factors assigned to one or more of the structural parameters based upon user input, and the results of the analysis are reported.

In more particular aspects, the invention provides a knowledge base and an expert system that cooperate to evaluate a structure's condition by combining parameters which characterize natural forces and events with information about the structure, its usage, its condition and its past history, with expert knowledge and inhabitant preferences and profiles in order to provide an accurate assessment of the structure and recommendations and guidance for maintaining the structure to minimize the effects of a triggering event at the structure. In particular, upon being notified of the occurrence of a triggering event and parameters which characterize the event and its location, the expert system using information stored in the knowledge base and parameters which characterize the event analyzes the impact of the event on the structure and one or more inhabitants and reports the analysis and recommendations.

### BRIEF DESCRIPTION OF THE DRAWINGS

FIG. 1 is a diagrammatic view of a computer information and management system of the type in which the invention may be employed;

FIG. 2 is a diagrammatic view illustrating a preferred embodiment of a system in accordance with the invention;

FIG. 3 is a flow chart of a preferred embodiment of an intelligent iterative query process with which a user interacts to create a user profile and preferences;

FIG. 4 is a diagrammatic view showing a method for creating a calendared event;

FIG. 5 is a flow chart illustrating an overview of a preferred embodiment of a process for analyzing the effect of an event on a structure; and

FIG. 6 is a flow chart which illustrates a generalized embodiment of an analysis process of FIG. 5.

### DESCRIPTION OF PREFERRED EMBODIMENTS

The invention is particularly well-adapted for evaluating and determining the effects of natural forces and events, such as weather and other such events, on residential or commercial buildings, facilities and other such structures and on occupants, inhabitants or users of the structure, and will be described in that context. As will become apparent, however, this is illustrative of only one utility of the invention, and that the invention has greater applicability. For example, the invention may be used to advantage for determining the impact of triggering events other than natural events, and is applicable to various types of structures and constructions other than buildings, as well as to industrial or commercial plants and systems. Accordingly, as used herein, the term “structure” is used in its broadest context to include not only buildings and other types of constructions, but also to include industrial plants, utility systems, and other types of commercial or industrial facilities or systems. Also, the terms “inhabitant” and “occupant” are sometimes used interchangeably herein to refer to individuals who occupy or use the structure on a temporary or permanent basis, or who are otherwise present at the structure upon the occurrence of a triggering event. The term “triggering event” refers to an event that impacts the condition of a structure or individual, and includes natural events comprising, for example, environmental or weather-related forces and occurrences such as earthquakes, hurricanes, tornadoes, storms, floods, fires, etc., and man-made events. Triggering events also include calendared or scheduled events such as structural or infrastructural system maintenance events to address conditions that may adversely impact an inhabitant of a structure who has a particular health or physical condition. An example of such an inhabitant's physical condition may be an acute respiratory condition, and the triggering event may be the replacement of an HVAC air filter to ensure maintenance of high air quality to avoid a possible respiratory attack.

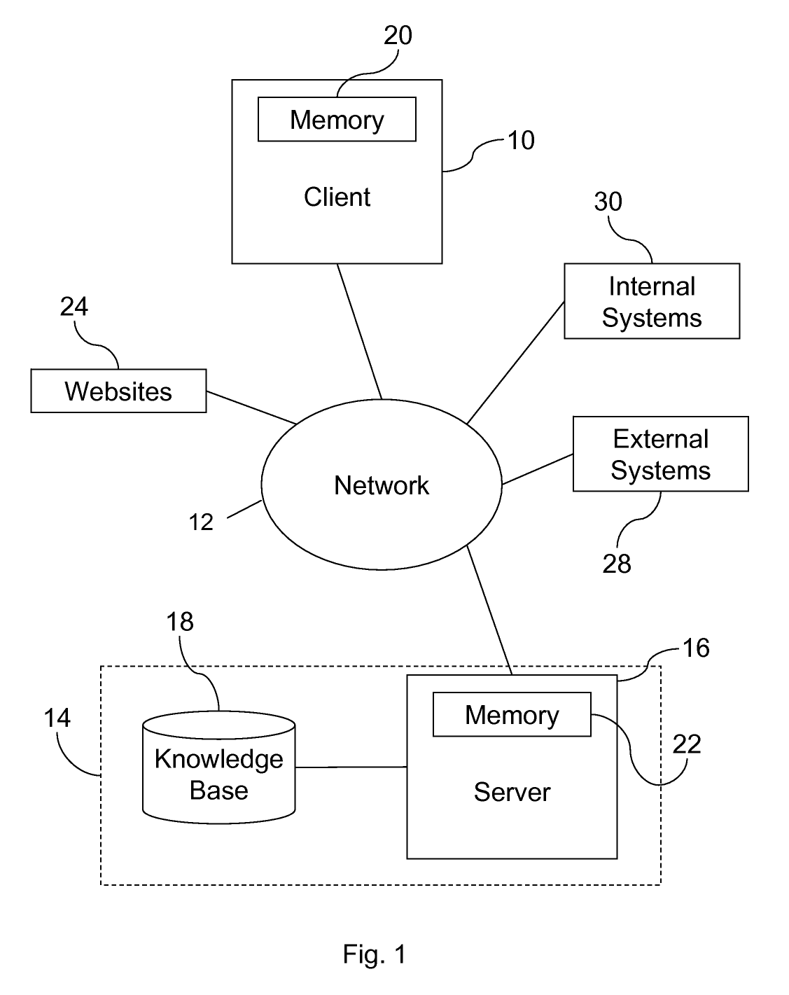

Referring to the drawings, FIG. 1 illustrates a computer information and management system of the type with which the invention may be employed. As shown, the computer system may comprise a computer network comprising a client computer system 10 connected via a network 12, such as the Internet, to a management system 14 comprising a server computer 16 and a knowledge base (KB) 18. As is well known, client computer system 10 may comprise a processor executing client computer application programs which may be stored in a memory 20. The programs include instructions for controlling the operation of the computer system processor. Memory 20 may also store data being processed by the computer system processor. Server 16 may similarly comprise a computer processor executing server computer application programs stored in a memory 22 which control the operation of the server 16. Client 10 may communicate with server 16 using a conventional web browser, and server 16 may receive and process requests for information from client 10. Knowledge base 18 may comprise a conventional database which stores data and information processed by server 16.

Client 10 is also sometimes referred to herein as a “user”, who may be an owner, inhabitant, or occupant of, or an individual otherwise associated with a structure. Client 10 may input parameters and other information to knowledge base 18 about the structure, as will be described in more detail shortly, and may provide an output to the user. Client 10 may also input into knowledge base 18 profile and preference information that is unique to the user, as will also be described in more detail shortly. This and other information and knowledge information will be used to analyze and evaluate the effect of events on the structure, as described below. As will be appreciated, there may be multiple clients 10 associated with multiple users and multiple structures communicating via network 12 with management system 14. Each client may input information and parameters to the knowledge base that are unique to an associated structure, as well as personal profile information that is unique to the user, such as health or physical conditions, or other preferences, and which are relevant to assess the impact and risk for various triggering events. Multiple websites 24, multiple external systems 28, and multiple infrastructure systems 30 (only one website, one external system, and one internal infrastructure system being illustrated in the figure) may be interfaced to network 12 for communication with clients and servers connected to the network. As will be appreciated, server system 14 may similarly comprise a website.

As noted, each client/user 10 may input to knowledge base 18 certain unique information which characterizes a structure as well as individuals such as occupants or others associated with the structure. For example, in the case of a building, a user may input to the knowledge base structural parameters that uniquely characterize the building. These structural parameters may include detailed information related to the design, type of construction, and materials used for constructing the building, its foundation and internal reinforcement, etc., and information describing the building maintenance history and its condition. Such parameters can be important for assessing the impact of a triggering event on the structure. A brick or steel reinforced building, for example, may be better able than a wood frame home to withstand the forces of high winds.

Additionally, the user may input parameters and information that uniquely characterize the situs or locale of the building, such as geological information about the substrata of the area in which the building is located, its elevation above sea level, and information about other natural objects or man-made structures within the vicinity of the building. The risk of fire, for example, is greater for structures located in wooded areas, and the risk of floods depends on the elevation of a structure, the terrain, and the presence of water sources in the vicinity. The user may also input to the knowledge base profile information concerning conditions and preferences unique to the user, as will be described in more detail shortly.

The knowledge base may also store information from industry professionals and experts that is useful for analyzing the impact of events on structures and their occupants, and for providing recommendations and guidance for maintaining structures to increase their ability to withstand and respond to triggering events, as well as to improve their safety, value and useful life. This expert information may be provided to the management system 14 via the network client 10, from websites 24 and from external systems 28. Finally, knowledge base 18 may also receive data and information about triggering events from external systems 28, such as notifications of the occurrences of natural or weather events and parameters which characterize the events. These external systems 28 may comprise, for example, services such as the National Oceanic and Atmospheric Administration's National Weather Service (http://www.weather.gov/gis/) that provides weather warnings and advisories by geography, the U.S. Geological Survey's Advanced National Seismic System's web-based GIS application for earthquake reporting (http://earthquake.usgs.gov/research/monitoring/anss/), and other similar such systems which monitor and automatically report information and data about natural forces and events. Server 16 of the information and management system 14 processes and analyzes information from knowledge base 18 and from external systems to determine the impact or effect of an event on a building or other structure, and reports the results of the analysis to the client/user 10 or to others, as will be described in more detail below.

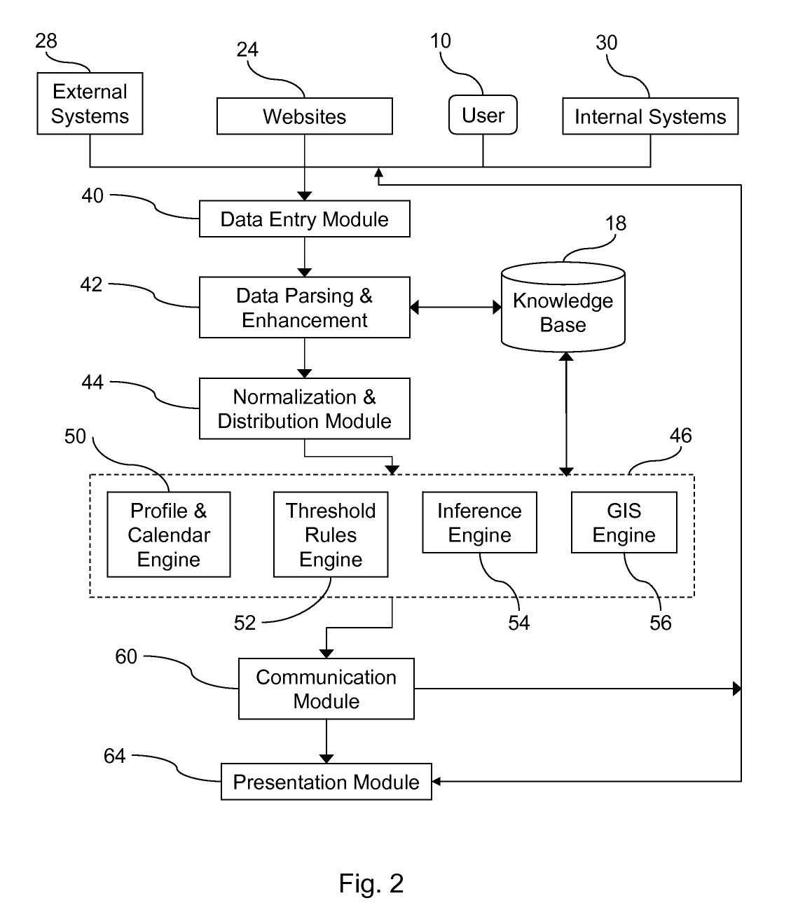

FIG. 2 illustrates a preferred embodiment of the computer information and management system 14 in more detail. As shown, the system may comprise a data entry module 40 that can receive input via network 12 from either a user (client) 10 or from one or more web sites 24 or external systems 28. As noted above, external systems 28 may comprise weather or other natural event monitoring, alerting, and/or forecasting services. External systems 28 that provide data or information may also comprise utilities (e.g., gas and electric) suppliers, for instance, that provide notifications of disruptions of utilities, and may include internal local infrastructure sensors in the structure, e.g., fire alarms, heating/cooling system alarms, gas leak or water line break sensors, and the like. Data and information input to data entry module 40 may be passed to a data parsing and an enhancement module 42. This module 42 may collect and manage information such as service records from the data entry module to produce event records that can be better used by various system processing components. Data parsing may include, for example, breaking up data for different processors of processing system 46 (as will be described), removing redundancies, and consolidating multiple records relating to the same event. Data enhancement may include, for instance, supplementing records with relevant data from other external systems or from websites.

A normalization and distribution module 44 may receive data from the data parsing and enhancement module 42, normalize event records, and distribute the normalized records to the various processors of a processing system 46. Module 44 may normalize data by converting event records data, which may be formatted in various ways, into appropriate formats for processing by the various processing engines of the processing system 46. As shown, and as will be described in more detail, these processors or engines may comprise a profile and calendar engine 50, a threshold/rules engine 52, an inference engine 54, and a geographic information system (GIS) engine 56. The engines 50-56 may comprise processes running in a CPU of processing system 46 and together comprise an expert system.

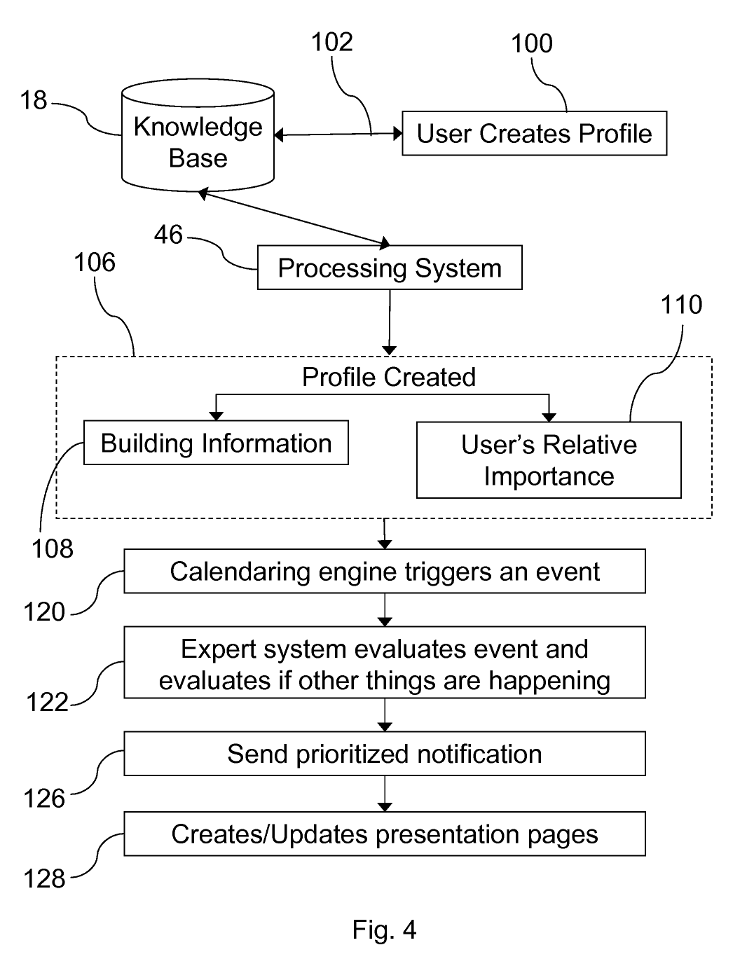

The profile and calendar engine 50 may generate unique triggering events and recommendations that are based upon knowledge that is true with respect to many different users, knowledge or conditions that are specific to one or more users, and preferences of a user, as will be described in more detail in connection with FIG. 4. This engine may also create and schedule certain calendared events, e.g., structural or infrastructure maintenance events, associated with a structure, and timely notify an occupant or an external maintenance service provider of a scheduled event. For example, a building occupant with respiratory problems may be more susceptible to illness or injury from events that impact the air quality. By inputting this type of profile or condition information into the system, the profile and calendar engine can schedule, manually or automatically using expert knowledge or information from sensors in infrastructure systems 30, for instance, more frequent than customary replacement of air filters in HVAC systems. Additionally, as will be described, the threshold/rules engine may establish preset thresholds and rules relating to air quality, and take appropriate actions based upon triggering events that can affect air quality.

The threshold/rules engine 52 may utilize expert knowledge and information from knowledge base 18, as well as individual conditions and user preferences, to monitor event records such as output from sensors that monitor infrastructure systems 30 for comparison with predefined rules and thresholds, and to trigger alarms or take other appropriate actions when the thresholds are exceeded. Thresholds and rules may be created, modified or deleted according to the evolving needs of individuals and users, even during operation of the threshold/rules engine. Rules may be customized for individuals and events, and may be updated manually or automatically according to changing patterns or conditions by a pattern recognition engine incorporated within the threshold/rules engine. The threshold engine 52 may also receive enhanced event records from an event record enhancer in the data parsing and enhancement module 42, and may select from a plurality of different stored rules based upon the values in vectors of event records. The values may relate to different occupant conditions or to different events. The threshold/rules engine may apply threshold rules based upon a current record and prior event values, and advantageously permits a dynamic set of rules and thresholds to be applied based upon varying events and circumstances.

GIS engine 56 may analyze the geographic information and event parameters from external GIS systems, such as the previously referenced web-based GIS earthquake information system, in relation to the geographic location of the structure. The GIS engine may, for example, estimate the magnitude of triggering event such as an earthquake at the location of the structure based upon data from the external GIS system.

Finally inference engine 54 processes the various parameters and information from the knowledge base and inputs from other engines to analyze the likely effect of a triggering event and the risks of injury and damage, and outputs the results of this analysis. The analysis may be output to a communications module 60 which may communicate with and control internal building/structure systems 30 as appropriate. For example, the inference engine may direct the communication module 64 to communicate with infrastructure systems 30 to control a shut off valve for the gas supply to the building in the event of an earthquake to prevent a fire, activate an HVAC system if an air quality sensor detects an air quality below an acceptable threshold for an occupant of the structure, or send notifications to third parties, as for instance via email.

The processing system's analysis and recommendations may also be presented to user 10 or to others via networks that provide voice notification, text messages and/or email, for example, by a presentation module 64. The presentation module may provide, for example, a graphical presentation to a user of the analysis of the structure along with recommendations for actions to be performed in response to the triggering event. The analysis may report as to the overall status and conditions from different perspectives, such as health, safety, value and efficiency. As will be described, this information may be presented graphically on a display to the user along with values which characterize the status and condition of the structure. The presentation module may also present other information, such as an event history.

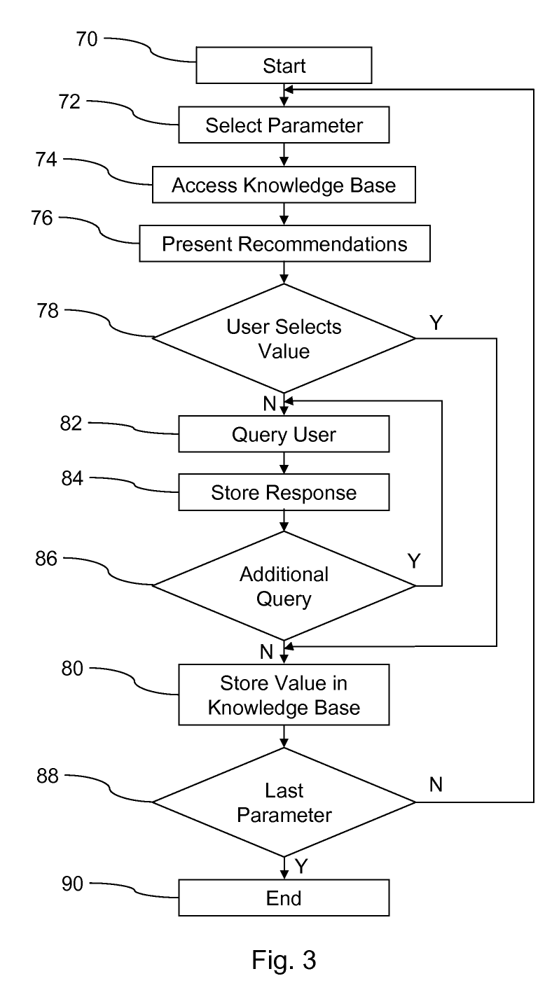

In order to accurately analyze the impact of an event on a structure and to provide sound recommendations to a user, it is desirable that rather comprehensive and accurate information and parameters which characterize the structure be available to the processing system. Moreover, accurate user profiles characterizing user's conditions and preferences are also desirable to enable the processing system to accurately assess the impact of triggering events that are unique to the users. The invention may provide an interactive query process which is controlled by the expert processing system 46 and may use expert knowledge from the knowledge base to obtain relevant and accurate information about the structure and individual conditions and preferences, as will be described in connection with FIG. 3. This query process is preferably an iterative one that educates the user by providing relevant information that teaches the user about the structure, explains the relevance and relationships among various factors that characterize the structure, and guide the user's selections of alternatives in order to enable the user to make intelligent choices.

FIG. 3 is a flow chart which illustrates a generalized embodiment of a data entry process which educates and guides a user through the date entry process by presenting recommendations which enable the user to intelligently choose parameter values. The process illustrated in FIG. 3 will be described in connection with obtaining structural parameters about a structure. However, it will become apparent from the following that this process may also be used for obtaining specific profile information about individuals and their conditions and preferences. As will be described, the process may comprise an initial data entry process, e.g., for structural parameters characterizing a structure. This enables the user to input unique information about a structure and any personal preferences to vary the baseline values of parameters for the structure that were either previously entered into the system or were determined by the processing system from standard expert recommendations and knowledge. This advantageously results in a more accurate set of parameters characterizing a structure and its users, and enables a better assessment of the effect of an event and the risk of damage or injury.

Referring to FIG. 3, the process starts at 70. At step 72 a parameter may be selected from a group of parameters that relate to a particular feature or characteristic, and which may be presented to the user by the presentation module 64. At 74, expert knowledge and recommendations relevant to the selected parameter are accessed from the knowledge base 18 and presented at 76 to the user to permit selection of a parameter value. If the parameter is, for example, “type of construction” the information from the knowledge base may comprise a list of various types of building constructions along with descriptions, information and baseline values from which the user can select. Each construction type may further have subcategories to allow greater specificity and precision in accurately specifying the type of construction and its characteristics. If the user is knowledgeable enough about types of construction to make a selection at 78, the value of that selection is added to the knowledge base at 80. If, however, the user is unable to make a selection or wishes guidance in making a selection, the user may be presented with a series of information and queries to guide the user through the selection process. In this case, at 82 a first query is presented to the user, and the user's response may be evaluated and stored in the knowledge base at 84. At 86, if there are additional relevant queries, the process returns to step 82 and another query is presented to the user, and the user's response is stored and evaluated at 84. Following the last query, the expert system may analyze the user's responses and store an appropriate value to the knowledge base at 80 for each parameter. The process then moves to step 88. If there are additional parameters for which values need to be selected, the process returns to step 72 and is repeated. If there are no additional parameters, the process ends at 90.

As may be appreciated, the process of FIG. 3 is driven by the expert processing system 46. It is an intelligent process which is able to respond to user inputs by using expert knowledge stored in the knowledge base 18 and/or obtained from websites 24 to select appropriate queries and recommendations to be presented to the user. This not only affords more specificity in selecting parameter values to characterize a structure and its environment, it also affords a learning experience by providing the user information relevant to the parameter being selected. Additionally, as will be appreciated, the process of FIG. 3 enables a user to control the selection of parameter values based upon the user's individual preferences as well as any specialized information which the user may have with regard to characteristics. For instance, if the user is aware that the construction of a particular building is stronger than other buildings of the same general type, or that the building was subsequently reinforced after construction, the user may increase the baseline weighting value assigned to that particular parameter. This increases the accuracy and personalization of the characterization of the building to afford a better assessment of the effects of events. This process will be illustrated in more detail below.

Advantageously, users may calendar certain selected triggering events that are unique to a particular building or structure as, for example, maintenance items that may influence the impact and effect that an external triggering event, such as a natural event, may have on the structure or an inhabitant due to a health or physical condition unique to the inhabitant. FIG. 4 is a diagrammatic view which illustrates this aspect of the system and method.

As shown, at 100 a user may create a profile for a particular triggering event and input that profile to knowledge base 18. This may cause the processing system 46, under the control of the knowledge base 18, to query the user at 102 using expert information in the knowledge base, as will be described in more detail below, to assist in establishing the profile. At 106, the processing system creates a profile and stores it in the knowledge base. As indicated in the figure, the profile may comprise information 108 about a particular structural parameter that is unique to the structure or an individual parameter that is unique to a condition of a particular user of inhabitant of a structure. The input may comprise weighting information 110 that indicates the relative importance to or preferences of the user relative to the particular parameter. This weighting, in effect, enables the user to vary what otherwise might be a recommended standard baseline threshold value based upon expert information for a particular action by changing the standard baseline threshold value or rule governing a triggering event. For example, the recommended frequency or time for a calendared maintenance event (e.g., replacing an air filter in an HVAC system) may be changed based upon a condition (e.g., a respiratory condition) or preference unique to the user or an inhabitant of the structure. Additionally, a rule may be created and stored for use by the threshold/rules engine that responds to the value output from an air quality sensor in the structure to notify the user to change the air filter when the air quality drops below a preset value to prevent illness or injury to the inhabitant. Other user-specific profiles and thresholds may be created based upon other user conditions and preferences. Once created, the profile for a new triggering event may be stored in knowledge base 18, and used by the threshold/rules or other processor engine to provide an appropriate notification when the event is triggered.

In the case of a calendared event, at 120 the profile and calendar engine 50 of processing system 46 responds to the profile stored in knowledge base 18 and initiates the associated calendared event. At 122, the processing system 46 evaluates the event and determines whether there are other current triggering events, e.g., natural or man-made events, which may impact the calendared event or cause other actions to be taken. At 126, a prioritized notification regarding the calendared event may be sent by the communications module 60 to internal or external systems to automatically take appropriate action, if possible, and may also be sent by the presentation module 64 to notify the user. This notification may be sent to the user as a reminder that it is time to perform a particular calendared maintenance action, or it may send a notification to an external service provider or contractor indicating that a calendared maintenance action is required. The notification may include an assigned level of importance or urgency related to safety, efficiency or value, for example. The notification to a user may include a list of suppliers or service providers that the user may employ to perform the calendared action. Once the calendared action has been performed, the knowledge base may be updated at 128 to reflect this fact and the changed condition or status for the structure. An appropriate indication may also be provided to the user via the presentation module 64.

As previously described, upon the occurrence of a triggering event, the system is notified of the occurrence of the event and parameters which characterize the event. The system processes expert information from the knowledge base and the event parameters to analyze and evaluate the effects of the triggering event on a structure and/or one or more of its inhabitants. As noted, the triggering event may comprise a natural event, such as a weather-related event, or a man-made or other event, such as a fire. The expert information in the knowledge base and parameters that are used by the processing system for analyzing the impact and effects of the triggering event on the structure or inhabitants depends on the nature and type of event. These parameters may comprise one or more of structural parameters which characterize the structure and its condition based upon its maintenance history, its location, its environment or locale, user preferences and importance weighting factors, individual parameters relating to conditions unique to the individual user or inhabitant, such as the user's age, health, mobility, physical condition, etc., event parameters relating to the characteristics of the triggering event, and expert knowledge relating to similar structures, conditions and triggering events.

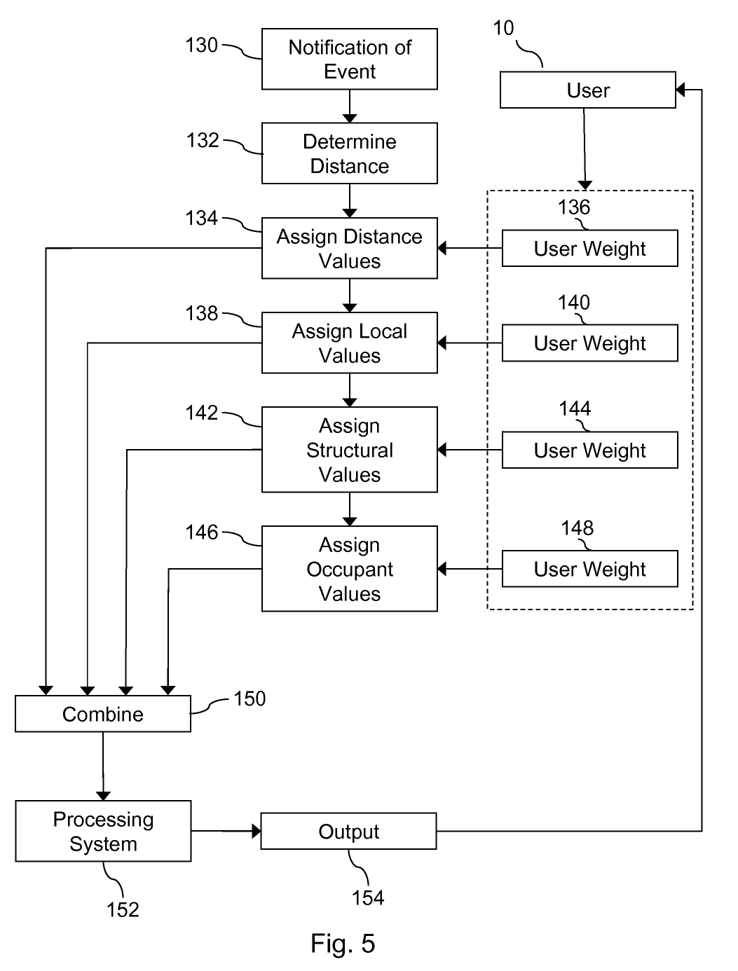

FIG. 5 is a flow chart which illustrates a preferred embodiment of a process in accordance with the invention for evaluating the effects of a natural or weather-related triggering event, such as an earthquake or a storm, on a structure and its occupants. Beginning at step 130, an external system provides notification of the occurrence of the triggering event and parameters which characterize the event. Next, at 132 the process determines the distance from the location of occurrence of the event to the location of the structure in question, and at 134 assigns a value to a distance risk factor. This value may be based on the proximity of the structure to the natural triggering event, as well as user weighting factors 136 based upon preferences input by the user and stored in knowledge base 18. Next, at 138 the process may assign risk factor values based upon the locale of the structure. Locale risk factors may be based upon parameters which characterize the environment of the structure. These may include, for example, geologic and geographic parameters for the area, the elevation of the structure relative to sea level and the surrounding area, the presence of natural and man-made objects in the vicinity of the structure, etc. Locale factors may include any factors which relate to things in the vicinity of the location of the structure which might have an impact on the structure upon the occurrence of an external event. Locale factors may also include user weighting factors 140 from knowledge base 18.

Next, at 142, the process may assign values to risk factors which characterize the structure itself based upon structural parameters. Structural parameters may include, for example, parameters which characterize the type and design of the structure, materials from which it is constructed, the condition and history of the structure, any special characteristics of the structure which may relate to its overall ability to withstand the effects of an external event, and the like. In addition, the values of the structure risk factors may be changed by user weighting factors 144 which may be based upon specialized user knowledge, user preferences and relative important values, for instance. Next, at 146, the system may assign risk factor values which characterize occupants or users of the structure, or others associated with the structure. These risk factors may include, for example, factors such as the number of occupants or users, their ages, their health, the type of use of the structure, etc. Additionally, user weighting factors 148 from the knowledge base may also be taken into consideration in assigning values of the occupant's risk factors.

User weighting factors 136, 140, 144 and 148, may be based upon specialized knowledge of the user, or relative importance values placed upon certain items by the user or the expert system for reasons of safety, health, efficiency and structure valuation, etc. As previously described, the user weighting factors may increase or decrease a value assigned to a particular parameter in order to give the parameter a greater or lesser effect in the analysis. For example, expert knowledge in the knowledge base may assign a baseline value for a structural parameter for a type of structure constructed of brick, and this baseline value will be combined with other structural parameter values, as for example by using a weighted average, to determine an overall structural parameter value for assessing the effect of the event on the structure. A user, however, may be aware of certain design characteristics unique to the structure, such as increased reinforcing which may increase the overall strength of the structure, and, accordingly, increase the value given to this structural parameter by the weighting factor applied at step 144. Additionally, a user may place a greater value and importance on certain parameters because of personal preferences or other information known to the user. The user weighting factors are thus used to vary the baseline values assigned to the various parameter risk factors determined by the knowledge base.

At step 150, the various risk factors from steps 130-148 may be combined and provided at step 152 to the processing system. The processing system may embody any of a number of well known analysis algorithms, e.g., such as a sum of weighted squares, to process the parameter values and expert knowledge from the knowledge base to analyze the effect of the event on the structure and to provide an output report at 154 to the user. This output may be a notification to the user or to another individual or entity from the communications module 60 (FIG. 2) and/or from the presentation module 64.

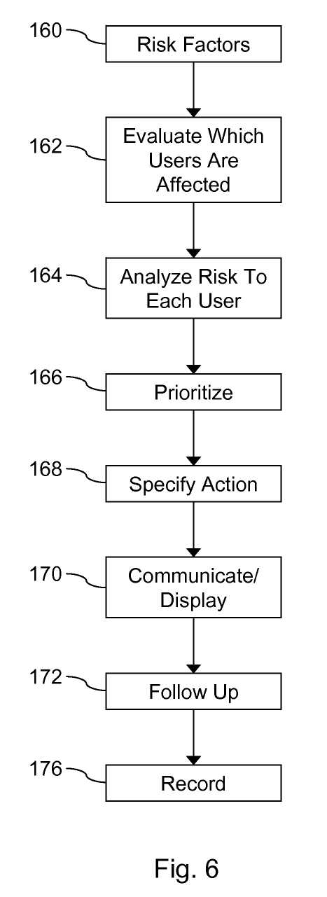

FIG. 6 is a flow diagram which illustrates in more detail a generalized embodiment of an analysis process performed by the processing system at 152 of FIG. 5. Referring to FIG. 6, at 160 the processing system receives the risk factors from step 150 of FIG. 5. Next, at 162, the process may evaluate which of a plurality of users may be affected by the triggering event, and at 164 the process analyzes the risk of injury to individuals. These steps may be performed for all structures for which the combined parameter risk values exceed a predetermined threshold value, or may be based upon another rule applied by the threshold/rules engine of processing system 46. Next, at 166 the process may prioritize communications and notifications based upon risk of damage or injury, for example, and at 168 it decides upon specific actions which should be taken. Next, at 170 the process communications notifications to users and others, such as emergency services, third party service providers, and other persons who may be requires to go to the assistance of affected occupants or users, and may output displays with an analysis of the effect of the external event on a structure. At 172, the process may provide follow up communications and notifications, as well as receive replies indicating which of the specified actions have been completed. Finally, at 176, the process may record the results of the analysis and follow up in knowledge base 18.

As an example of the operation of a system and process in accordance with the invention, assume that the triggering event is a natural event comprising an earthquake having a magnitude of 7.0 with an epicenter located in Santa Cruz, Calif. The system may automatically receive information and parameters which characterize the earthquake from an external system, such as, for example, from the previously referenced GIS Reporting System for Earthquake Information of the National Earthquake Information Center (NEIC), a branch of the U.S. Geological Survey. This information may include information on the magnitude of the earthquake and the location of its epicenter, as well as the magnitudes of the tremor at various geographic locations in the San Francisco Bay area.

The system may then determine which users may be affected by the earthquake and its impact on the users based upon their locations relative to the epicenter, as was described in connection with FIG. 6. For example, buildings close to Santa Cruz are obviously going to be more affected than those that are further from the epicenter, and structures that are located on the particular fault that produced the earthquake or on another related fault may be even more affected than structures which are not on the fault. The system may collect and process such event-related parameters to establish a profile of the earthquake event in the knowledge base. The expert system may then analyze the event data from the knowledge base along with expert knowledge and the other relevant factors as described previously, including user personal preferences and conditions, to determine the effect on particular users and structures.

For example, in San Francisco, the magnitude of the earthquake, which was 7.0 at Santa Cruz, may have diminished to a value of 6.7, and expert knowledge in the knowledge base may indicate that on a risk level from 0-10, with a value of 10 being the highest risk, a magnitude 6.7 earthquake has a risk level value of R=8. The system may then assign that value as a baseline for structures in San Francisco. Next, the system may determine whether there are other recent or concurrent events such as weather-related events or fires that could vary the effect in San Francisco. If so, the system will assign appropriate weighting factors to parameters to determine the effects on structures in San Francisco.

Next, the system may look to the locale factors to evaluate particular elements of risk to the structure. For example, even within a relatively small area, such as the city of San Francisco, the geologic characteristics of the earth may vary greatly. If a building at a particular location is constructed on a foundation of solid rock, the baseline risk level may remain at R=8, for example. However, if a building is on landfill, the risk level of damage may be increased to a value of R=12. The system may then consider structural parameters that are characteristics of each structure. If a building is an old brick building that was not reinforced, the overall risk factor may rise to a value of R=20. If, however, the building is a structure built according to newer earthquake construction codes, the risk factor may remain at R=12. The system will then continue through various structural parameters of the building and assign values based upon expert knowledge and user inputs.

The system and process may next consider things that are unique or important to users, such as user conditions and preferences that are not directly related to a structure or its locale, and consider these user parameters in the analysis. For example, if one or more occupants of a particular building are infirm or have mobility problems, the overall risk of injury for a given triggering event may be increased significantly, and it may be important to notify emergency authorities or a third party to go to the building to take care of the occupants. On the other hand, if a building is vacant and all utility systems such as gas and electric are turned off, the overall risk factor for that building may be decreased. The system may additionally look at particular sensitivities of occupants, such as whether occupants have allergies or other health problems that may be triggered by the earthquake, and assess which are the most important health factors relative to such individuals. The system may also determine whether other triggering events have occurred in the past and look to recommendations and actions taken for those events.

The degree to which such factors and parameters as described may influence the analysis of the effect of an event may be determined by the various rules or other processing algorithms applied by the processing system in the analysis. As indicated previously, the system may simply determine weighted averages for related parameters, such as structural parameters, and apply predetermined thresholds and rules to assess their significance to the analysis. Based upon the analysis of the various factors and parameters characterizing the triggering event, the structure, the locale and the users, the system may generate a risk analysis, report the analysis and conclusions, and provide notifications. The analysis may take into consideration the user preferences and relative importance factors, which may affect the overall conclusion and analysis, as well as the expert advice and guidance provided. It may provide recommendations and a list of prioritized action items to mitigate additional damage or injury. The system may further send out alarm notifications and prioritized to-do action item lists for various structures based upon expert knowledge in the knowledge base. Upon performing the action items on the list, users may record this in the knowledge base so that it becomes part of the history of a particular structure and can be used for analyzing the effects of future events.

Although the foregoing example used an earthquake as a natural triggering event, it will be appreciated that the invention may similarly analyze the impact and risk due to other types of events, such as hurricanes, tornadoes, storms, fires, etc.

As will also be appreciated, the system and method of the invention may also be used to provide a pre-event analysis based upon known and assumed parameters, and provide reports with hypothetical analyses and prioritized action item lists that permit owners and occupants of structures to assess possible damage or injury in advance of a triggering event and take appropriate preventive measures. The system and method of the invention may also be used to perform an analysis of a structure using the stored parameters and expert knowledge and input from infrastructure system sensors, and indicate how to make the structure more efficient and environmentally friendly.

While the foregoing has been with reference to particular embodiments of the invention, it will be appreciated that changes in these embodiments may be made without departing from the principals and the spirit of the invention, the scope of which is defined by the appended claims.

1. A computer-implemented method of evaluating the effect of a triggering event at a structure, comprising:
receiving notification of said triggering event and event data that characterize said triggering event;
obtaining structural parameters that characterize the structure and weighting factors assigned to one or more of said structural parameters based upon user input;
analyzing the effect of said triggering event at the structure using said event data, said structural parameters, and said weighting factors; and
reporting said analysis.

2. The method of claim 1, wherein said analyzing further comprises analyzing the impact of said triggering event on an individual at said structure using individual parameters that characterize said individual, said individual parameters at least in part relating to a physical condition of said individual which influences the impact of said triggering event on said individual.

3. The method of claim 2, wherein said analyzing comprises using predetermined rules and thresholds to determine a risk of damage to the structure or of injury to said individual due to said triggering event, and said reporting comprises providing notice of said risk.

4. The method of claim 2, wherein said triggering event comprises a scheduled event established by an expert system based upon said individual parameters to address said physical condition of the individual.

5. The method of claim 1, wherein said triggering event comprises a natural event, and said receiving notification comprises receiving notification of said event data from a system that reports data that characterize said natural event.

6. The method of claim 5, wherein said analyzing comprises determining said risk of damage using parameters relating to one or more of a location of said natural event, a magnitude of said natural event, and a locale of said structure.

7. The method of claim 5, wherein said structure comprises a building, and said structural parameters comprise parameters that characterize one or more of the design, construction, condition and maintenance history of the building.

8. The method of claim 5 further comprising analyzing the effects of said natural event on a plurality of structures within a selected geographical region, and said reporting comprises providing notifications as to those of said plurality of structures that have a potential of damage from said natural event.

9. The method of claim 1, wherein said analyzing comprises assigning baseline values to said structural parameters using expert knowledge, and modifying the baseline values of said one or more of said structural parameters using said weighting factors, said weighting factors being generated using an interactive process that educates the user to input relevant information about a weighting factor.

10. The method of claim 9, wherein said analyzing further comprises analyzing said effect using said values of said structural parameters and event data with predetermined rules and thresholds.

11. The method of claim 1, wherein said reporting comprises notifying of actions to be taken in response to said triggering event to minimize damage or injury.

12. The method of claim 11, wherein said reporting comprises communicating with infrastructure systems at said structure to control said systems.

13. A system for evaluating the effect of a triggering event at a structure, comprising:
a knowledge base storing expert knowledge, structural parameters characteristic of said structure, and weighting factors for one or more of said structural parameters assigned based upon user input;
an interface for receiving event data that characterize said triggering event;
an expert system for processing said expert knowledge, said structural parameters, said event data, and said weighting factors to analyze the effect of said triggering event at the structure; and
a module for reporting said analysis.

14. The system of claim 13, wherein said expert system further comprises a profile engine for generating said weighting factors, said weighting factors modifying values of said one or more structural parameters, said profile engine comprising an interactive query process controlled by said expert system which educates the user to input relevant information for generating said weighting factors.

15. The system of claim 14, wherein said event comprises a natural event, and said analysis is based upon a location of said natural event and a location of said structure.

16. The system of claim 15, wherein said structural parameters comprise parameters that characterize one or more of the design, construction, condition and history of said structure, and wherein said analysis is further based upon parameters that characterize a locale of said structure.

17. The system of claim 16, wherein said natural event comprises an earthquake, and wherein said system analyzes the effect of the earthquake on said structure and reports appropriate actions.

18. The system of claim 13, wherein said knowledge base further stores individual parameters characteristic of an individual at said structure, and said expert system processes said individual parameters to analyze the effect of said triggering event on said individual.

19. The system of claim 18, wherein said triggering event comprises a scheduled event related to said structure, and said individual parameters relate to a physical condition of said individual.

20. The system of claim 13, wherein said expert system further comprises a rules and threshold engine that applies predetermined rules and thresholds to said structural parameters, said event data and said weighting factors to analyze the effect of said triggering event.

21. The system of claim 13, wherein said module provides a notification about the effect of the triggering event at said structure.

22. A program product for storing instructions for controlling the operation of a computer to perform a method of evaluating the effect of a triggering event at a structure, comprising:
receiving notification of the triggering event and data characterizing the event;
obtaining structural parameters characterizing the structure and associated weighting factors assigned based upon user input to one or more of said structural parameters;
analyzing the effect of said triggering event at the structure using said event data and said structural parameters; and
reporting the analysis.

23. The program product of claim 22, wherein said analyzing comprises assigning baseline values to said one or more structural parameters using expert knowledge, and modifying the baseline values of said one or more of said structural parameters based upon said weighting factors, said weighting factors being generated using an interactive query process controlled by an expert system which educates the user to input relevant information for generating said weighting factors.

24. The program product of claim 23 further comprising analyzing the impact of said triggering event on an individual at said structure using individual parameters that characterize said individual, said individual parameters at least in part relating to a physical condition of said individual which influences the impact of said triggering event on said individual.

25. The program product of claim 24, wherein said triggering event comprises a natural event, and said receiving notification comprises receiving notification of said event data from a system that reports data that characterize said natural event.
